(19) United States
(12) Patent Application Publication
(10) Pub. No.: US 2005/0005503 A1
(43) Pub. Date: Jan. 13, 2005

(54) Fly trap

(76) Inventor: Michael Eugene Bragg, Aurora, CO (US)

Correspondence Address: Michael E. Bragg, 14323 E. Saratoga Place, Aurora, CO, 80015, US

(21) Appl. No.: 10/607,936

(22) Filed: Jun. 30, 2003

(51) Int. Cl. A01M 1/14

(52) U.S. Cl. 43/115

(57) ABSTRACT

A fly trap that is effective, attractive, quiet, safe, and pleasant. When placed or hung above eye level, the fly trap appears to be an ordinary ornamental artificial plant. Artificial plant stems are embedded in a container containing a filler material dense enough to hold the stems in place. The artificial plant stems are placed only near the inside of the upper rim of the container, leaving the center area clear. Into the center area is placed a piece of flypaper with an adhesive surface for immobilizing flies. Either the flypaper, the filler material, or both contain a bait or attractant to lure flies to the flypaper, where the flies become stuck to the adhesive surface and are unable to escape. When the adhesive surface becomes full of trapped flies, the used flypaper can be discarded easily and quickly, and replaced with a fresh piece of flypaper.

### FIELD OF THE INVENTION

The present invention relates to fly catchers and traps, and, more particularly, to a fly trap that is attractive, inoffensive and safe while removing flies from places where people gather.

### BACKGROUND OF THE INVENTION

Flying insects, such as the common housefly, are an annoyance and health problem in areas where people gather, especially those areas where food or drink is stored, prepared, served or consumed. A clean, safe, quiet, attractive, inoffensive, unobtrusive method of removing flies from areas where people gather has long been sought.

Chemical sprays that repel or kill flies, fly swatters, flypaper strips, and an assortment of mechanical and electrical fly traps have been used in an attempt to solve the fly pest problem.

All previous attempts to remove flies from a given area where people gather have been unpleasant, repulsive, unappetizing, noisy, impractical, obnoxious, unhealthy, or a combination of the above. In areas where food is stored, prepared, served or consumed, the shortcomings of other solutions become more obvious and more serious. Fly swatters are impractical, noisy and unclean, especially in a kitchen or restaurant setting. Chemical sprays, even scented ones, are unpleasant and unappetizing, and can be dangerous to breathe or get on ones skin or food. Flypaper strips are repulsive and unappetizing to look at and unsafe to touch. Electric traps are obtrusive and noisy and can spread fly parts over a wide area. Mechanical traps currently available are obtrusive and unappetizing. As a result, most restaurants and private homes have chosen to live with the flies rather than employ any of the existing methods for removing flies from areas where people gather.

U.S. Pat. No. 6,178,687, issued to Steven Frisch, represents an attempt to solve the fly pest problem based on the use of flypaper. Such a piece of flypaper would be unclean, offensive, and unappetizing when used in an area where people gather, especially in the presence of food or drink.

U.S. Pat. No. 6,438,894, issued to Kenneth Silvandersson, is an attempted mechanical solution to the fly pest problem, which would be obtrusive, unattractive, and difficult to service in an area where people gather.

U.S. Pat. No. 5,815,981, issued to Earl Dowling and Todd Hummelle uses flypaper with an adhesive surface to catch flies, but is unattractive and unappetizing.

It is therefore an object of the invention to provide a trap for removing flies from places where people gather

It is another object of the invention to remove flies from places where people gather in an effective, attractive, safe, quiet, practical, pleasant manner.

It is another object of the invention to provide a fly trap that appears to be an ordinary ornamental plant when placed or hung above eye level.

It is another object of the invention to provide for quick, easy removal of dead flies.

### SUMMARY OF THE INVENTION

In accordance with the present invention, there is provided a fly trap that is effective, attractive, quiet, safe, practical, and pleasant. When disposed above eye level, the fly trap appears to be an ordinary ornamental artificial plant. Artificial plant stems are embedded in a container filled with a material dense enough to hold the plant stems in place as in any artificial plant, except that the plant stems are placed only near the inside of the upper rim of the container, leaving the center area clear. Into the center area is placed a piece of flypaper with an adhesive surface for immobilizing flies. Either the flypaper, the filler, or both are imbued with a bait or attractant to lure flies to the flypaper, where the flies become stuck to the adhesive surface and are unable to escape. The flypaper is not attached to the filler material, so that when the adhesive surface becomes full of trapped flies, the flypaper can easily and quickly be discarded and replaced with a fresh piece of flypaper.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective top view of a fly trap in accordance with the invention, omitting for clarity some of the artificial plant stems which would normally be embedded in the filler material entirely around the inside of the upper rim of the container.

For purposes of clarity and brevity, like elements and components will bear the same designations and numbering throughout the FIGURES.

### DESCRIPTION OF THE PREFERRED EMBODIMENT

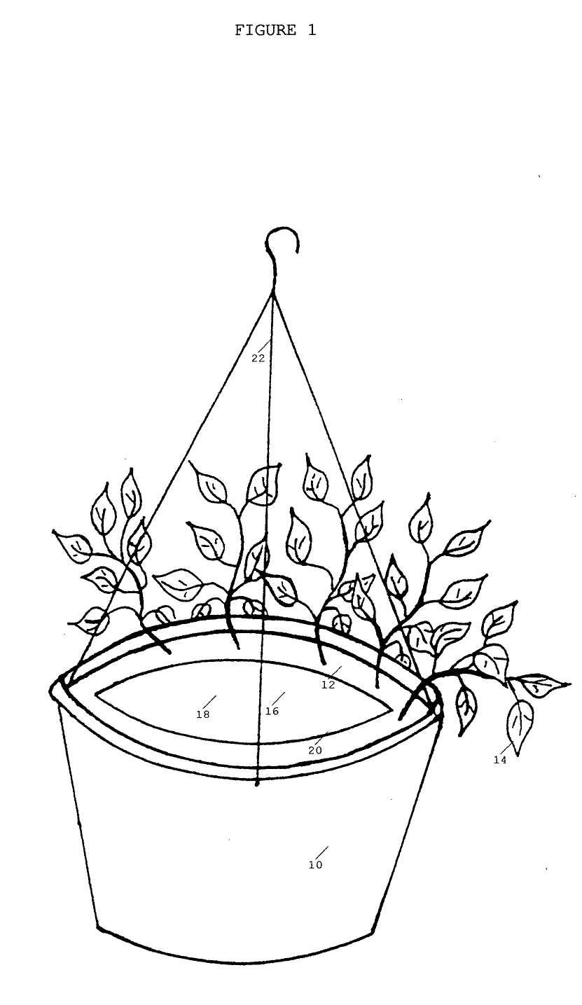

FIG. 1 is a perspective top view of a fly trap in accordance with the invention. For clarity, artificial plant stems 14, which surround and hide a piece of flypaper with an adhesive surface, are shown placed around only a portion of the inside of the upper rim of the container 10. In practice, the artificial plant stems 14 would be imbedded in the filler material 12 continuously around the entire inside of the upper rim of the container 10 in order to give the appearance of being an ordinary decorative artificial plant. The container 10 can be of various shapes, sizes and colors to suit the area in which it is to be used. Examples of suitable containers can be seen in craft stores or any store that sells pots to be used with either real or artificial plants. The containers are commonly made of plastic, pottery or metal, though other materials such as cardboard could serve. The container 10 would not have to be made specifically or use with real or artificial plants. In a fine restaurant or the living area of one's home, a well-crafted earthenware container 10 might be preferable. In a drive-through restaurant or home barbecue area, a cheaper material such as plastic might be preferable. The container 10 must be large enough to hold the filler material 12, the flypaper with an adhesive surface and the artificial plant stems 14, without being too large for the spot in which it is to be placed or hung. If the container 10 is to be placed on a flat surface, the bottom of the container 10 must be generally flat for stability. If the container 10 is to be hung in place, a hanger apparatus 22, one example of which is shown in FIG. 1, can be attached to the container 10 and attached to an overhead support. The hanger apparatus 22 can be made of various materials, including but not limited to wire, cloth, rope, string, and plastic. The hanger apparatus 22 can be attached to the container 10 and to the overhead support in various ways, including but not limited to tying, nailing, hooking, and screwing.

The container 10 must be placed or hung above eye level in order to maintain the illusion of being an ordinary artificial plant. The bottom of the container 10 must be sealed to prevent filler material 12 from leaking out. The sides of the container 10 must be sealed to prevent filler material 12 from leaking out, unless openings are left intentionally for the insertion of artificial plant stems 14. The top of the container 10 must be open to provide access to the flypaper, and for the insertion of the artificial plant stems 14.

The filler material 12 must be dense enough to hold the artificial plant stems 14 in place when the artificial plant stems 14 are embedded in the filler material 12, yet not so dense as to prevent the artificial plant stems 14 from being embedded in the filler material 12. Foam polystyrene and fibrous cloth products currently available at craft stores are suitable for use as the filler material 12, as are other filler materials including but not limited to dirt.

The artificial plant stems 14 must contain sufficient artificial leaves or flowers or both, and be of sufficient length, to give the appearance of a robust artificial plant when embedded around the inside of the upper rim of the container 10. Artificial plant stems 14 can be found in retail outlets that carry artificial plant stems 14, such as craft stores, or acquired from a manufacturer of artificial plant stems 14 or from any agent who deals in the distrubution of artificial plant stems 14.

Although the flypaper with adhesive surface can be found in retail stores, it may be preferable or necessary to order the flypaper with adhesive surface from a manufacturer in order to get the correct size and shape to fit the space inside the artificial plant stems 14. The flypaper and the adhesive may be acquired separately, in which case, the adhesive would have to be applied to the upper surface of the flypaper. The flypaper with the adhesive surface must be placed with the adhesive side upward in order to be effective in trapping and holding flies. The flypaper can be purchased with the attractant 20 pre-applied by the manufacturer, or the attractant 20 can be purchased separately and applied to the fly paper with adhesive surface. The attractant 20 can also be applied to the filler material 12, or can be applied to both the flypaper with adhesive surface and to the filler material 12.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. A fly trap for removing flies from places where people gather comprising:
means for holding the filler material, the artificial plant stems, and the flypaper;
means for providing a medium in which the plant stems can be held firmly in place, and upon which the fly paper can be placed, entirely inserted to said means for holding the filler material, the artificial plant stems, and the flypaper;
means for giving the fly trap the appearance of being an ordinary decorative artificial plant, firmly embedded to said means for providing a medium in which the plant stems can be held firmly in place, and upon which the fly paper can be placed;
means for catching and holding flies that touch said adhesive surface, removably positioned to said means for providing a medium in which the plant stems can be held firmly in place, and upon which the fly paper can be placed;
means for catching and holding flies, permanently bonded to said means for catching and holding flies that touch said adhesive surface; and
means for attracting flies to the flypaper with adhesive surface, permanently imbued to said means for catching and holding flies that touch said adhesive surface, and periodically imbued to said means for providing a medium in which the plant stems can be held firmly in place, and upon which the fly paper can be placed.

2. The fly trap in accordance with claim 1, wherein said means for holding the filler material, the artificial plant stems, and the flypaper comprises an open top container.

3. The fly trap in accordance with claim 1, wherein said means for providing a medium in which the plant stems can be held firmly in place, and upon which the fly paper can be placed comprises a disposed in the container filler material, having a predetermined density.

4. The fly trap in accordance with claim 1, wherein said means for giving the fly trap the appearance of being an ordinary decorative artificial plant comprises an array of artificial plant stems.

5. The fly trap in accordance with claim 1, wherein said means for catching and holding flies that touch said adhesive surface comprises a sized to fit inside the area surrounded by said artificial plant stems, shaped to fit inside the area surrounded by said artificial plant stems flypaper.

6. The fly trap in accordance with claim 1, wherein said means for catching and holding flies comprises an applied to the upper surface of the flypaper adhesive.

7. The fly trap in accordance with claim 1, wherein said means for attracting flies to the flypaper with adhesive surface comprises an able to be incorporated into said flypaper with adhesive surface and into said filler material, attracts flies attractant.

8. A fly trap for removing flies from places where people gather comprising:
an open top container, for holding the filler material, the artificial plant stems, and the flypaper;
a disposed in the container filler material, having a predetermined density, for providing a medium in which the plant stems can be held firmly in place, and upon which the fly paper can be placed, entirely inserted to said container;
an array of artificial plant stems, for giving the fly trap the appearance of being an ordinary decorative artificial plant, firmly embedded to said filler material;
a sized to fit inside the area surrounded by said artificial plant stems, shaped to fit inside the area surrounded by said artificial plant stems flypaper, for catching and holding flies that touch said adhesive surface, removably positioned to said filler material;
an applied to the upper surface of the flypaper adhesive, for catching and holding flies, permanently bonded to said flypaper; and
an able to be incorporated into said flypaper with adhesive surface and into said filler material, attracts flies attractant, for attracting flies to the flypaper with adhesive surface, permanently imbued to said flypaper, and periodically imbued to said filler material.

9. The fly trap as recited in claim 8, further comprising:
a method for being attached to the container, method for being attached to an overhead support hanger apparatus, for hanging container from an overhead support, suitably connected to said container.

10. A fly trap for removing flies from places where people gather comprising:
an open top container, for holding the filler material, the artificial plant stems, and the flypaper;
a disposed in the container filler material, having a predetermined density, for providing a medium in which the plant stems can be held firmly in place, and upon which the fly paper can be placed, entirely inserted to said container;
an array of artificial plant stems, for giving the fly trap the appearance of being an ordinary decorative artificial plant, firmly embedded to said filler material;
a sized to fit inside the area surrounded by said artificial plant stems, shaped to fit inside the area surrounded by said artificial plant stems flypaper, for catching and holding flies that touch said adhesive surface, removably positioned to said filler material;
an applied to the upper surface of the flypaper adhesive, for catching and holding flies, permanently bonded to said flypaper;
an able to be incorporated into said flypaper with adhesive surface and into said filler material, attracts flies attractant, for attracting flies to the flypaper with adhesive surface, permanently imbued to said flypaper, and periodically imbued to said filler material; and
a method for being attached to the container, method for being attached to an overhead support hanger apparatus, for hanging container from an overhead support, suitably connected to said container.
